(19) United States
(12) Patent Application Publication
(10) Pub. No.: US 2015/0290981 A1
(43) Pub. Date: Oct. 15, 2015

(54) TIRE SIDEWALL MARKINGS REDUCING AERODYNAMIC DRAG

(71) Applicants: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(72) Inventors: Eric BERGER, Clermont-Ferrand (FR); Benoit GARDARIN, Clermont-ferrand (FR); Bruno GUIMARD, Clermont-ferrand (FR); Olivier MUHLHOFF, Clermont-ferrand (FR)

(73) Assignees: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(21) Appl. No.: 14/441,378

(22) PCT Filed: Oct. 18, 2013
(86) PCT No.: PCT/EP2013/071885

§ 371 Date: May 7, 2015

(30) Foreign Application Priority Data
Nov. 9, 2012 (FR) 1260663

(51) Int. Cl. B60C 13/00; B60C 5/00

(52) U.S. Cl. CPC B60C 13/001; B60C 5/00

(57) ABSTRACT

Tire for a passenger vehicle, including a crown portion on its exterior with a tread, extended laterally by sidewalls terminating in beads to contact with rim parts (J) on which the tire is mounted, each sidewall including an inner wall and an outer wall, at least one of the sidewalls includes a plurality of first sectors and second sectors, formed on the outer wall of a first sidewall portion between the crown portion the axially outermost points when this tire is mounted inflated, wherein the first sectors are completely without raised markings, i.e. raised markings of a height greater than 0.2 mm, whereas the second sectors are provided with raised markings, these raised markings having a height equal to at least 0.2 mm, wherein the first sectors each form an angle equal to at least 20°, and wherein the sum of the angles of said first sectors is equal to at least 120°.

This application is a 371 national phase entry of PCT/EP2013/071885, filed 18 Oct. 2013, which claims benefit of French Patent Application No. 1260663, filed 9 Nov. 2012, the entire contents of which are incorporated herein by reference for all purposes.

### BACKGROUND

1. Field

The present disclosure concerns an improvement to the marking of tires conferring on them better aerodynamic performance when rolling compared to ordinary tires.

2. Description of Related Art

The important role of the tires equipping a passenger vehicle in energy consumption, notably through the energy losses linked to the cyclic deformations to which the tires are subjected, has already been established.

Substantial improvements have been obtained through the use in the construction of tires of materials having appropriate characteristics.

The present disclosure explores another path resulting from experimental observations carried out in a wind tunnel on tires when rolling.

A tire usually includes a crown portion provided on the outside with a tread intended to come into contact with a road surface when rolling. This crown portion is extended laterally by sidewalls terminating in beads intended to be in contact with rim portions.

The sidewalls of the tires generally have an appropriate flexibility to enable easy flexing on coming into contact with the road surface when rolling. The inner wall of the sidewalls is in contact with the air inflating the tire while the outer wall of the sidewalls is in contact with the external air in which the vehicle and the tires of the vehicle are moving.

Various wind tunnel tests have been carried out and have enabled the applicants to determine the significant portion of the energy loss linked to aerodynamic (notably drag) effects of the tires on the front axle of a vehicle at a plurality of rolling speeds from 80 kph and up to 220 kph.

A device able to drive the tires of a vehicle at a particular speed is installed in a wind tunnel, these tires being inflated and crushed under the conditions of use of the vehicle. On the basis of these tests and measurements it has been established that the sidewalls of the front tires and more specifically the sidewalls located on the outside of the vehicle cause a loss of energy (aerodynamic drag), this loss causing an increase in the coefficient Cx and thus an increase in the consumption of the vehicle in use.

A portion of these energy losses seems to be linked to the presence of raised markings (letters, digits, logo, etc.) on the sidewalls of the tires. A marking is referred to as “raised” in the present application if it projects toward the outside of the sidewall. In contrast, a recessed marking is formed within the thickness of the sidewall and therefore has no sharp edges on said sidewall.

According to the regulations, tires intended to be offered for sale must include on their sidewalls a certain number of markings notably indicating the size of the tire, manufacturing information (country, date) and various other useful information. Other information appears on the sidewalls: the brands of the tires and the logos of the manufacturer are molded in, in order to enable the customer to know the source of the tires they are using. Generally speaking, all this information is molded in during molding and vulcanization of the tire by the manufacturer.

There can be distinguished on each sidewall a first sidewall portion and a second sidewall portion. The first sidewall portion is located radially outside the points axially farthest from the equatorial plane when the tire is mounted on its mounting rim and inflated to its pressure of use. The second portion extends the first portion and is located radially inside this first portion. The second portion is joined to a bead of the tire.

During the wind tunnel tests, it was observed that the markings—which are essential in order to be able to offer the tires for sale—were not without effect on the aerodynamic drag, especially if these markings were located in the first portion (i.e. the radially outermost portion of the sidewall).

To establish a benchmark for the performance to be achieved, the performance of smooth tires was measured, i.e. tires with the sidewalls completely without raised markings.

### DEFINITIONS

Equatorial median plane: this is a plane perpendicular to the rotation axis and passing through the points of the tire radially farthest from said axis.

In the present document by radial direction is meant a direction that is perpendicular to the rotation axis of the tire (this direction corresponds to the direction of the thickness of the tread).

By transverse or axial direction is meant a direction parallel to the rotation axis of the tire.

By circumferential direction is meant a direction that is tangential to any circle centred on the rotation axis. This direction is perpendicular both to the axial direction and to a radial direction.

By axially outward is meant a direction that is oriented toward the exterior of the internal cavity of the tire.

The usual conditions of rolling of the tire or conditions of use indicated in the present document are those that are defined by the E.T.R.T.O. standard; these conditions of use specify the reference inflation pressure corresponding to the load capacity of the tire indicated by its load index and its speed code. These conditions of use may also be referred to as “nominal conditions” or “usage conditions”.

### SUMMARY

The present invention, in an embodiment, aims to approach or even to achieve with tires provided with raised markings on their sidewalls the aerodynamic drag performance of tires provided with smooth sidewalls.

To this end, an embodiment of the invention consists in a tire for a passenger vehicle, this tire comprising a crown portion provided on its exterior with a tread intended to come into contact with a road surface when rolling, this crown portion being extended laterally by sidewalls terminating in beads intended to be in contact with rim portions on which the tire is mounted.

Each sidewall includes an inner wall in contact with the air inflating the tire and an outer wall in contact with the external air.

In accordance with an embodiment of the invention, at least one of the sidewalls includes a plurality of first sectors and second sectors, these first and second sectors being formed on the outer wall of its first sidewall portion located between the crown portion and the points that are the axially outermost points when this tire is mounted on its mounting rim and inflated to its usage pressure.

The first sectors are completely without raised markings (that is to say raised markings more than 0.2 mm high) whereas the second sectors are provided with raised markings, these raised markings having a height equal to at least 0.2 mm. Furthermore, the first sectors without markings each form an angle equal to at least 20° and the sum of the angles of said first sectors is equal to at least 120°.

It has been verified, unexpectedly, that the aerodynamic drag performance of a tire the sidewalls of which are smooth (that is to say without raised markings at least 0.2 mm high) can be achieved by a tire nevertheless including raised markings—which are therefore particularly legible for an observer. In an equivalent manner, in the present document absence of raised markings at most 0.2 mm high must be understood as a sidewall having a surface roughness equal to at most 0.2 mm.

In a preferred embodiment, the first sectors may be provided with recessed markings (as opposed to raised markings, recessed markings form no raised sharp edges on the sidewall). These recessed markings have a depth equal to at most 1.5 mm and preferably between at least 0.5 mm and at most 0.8 mm.

The raised markings advantageously have a height equal to at most 1.5 mm and even more preferably between 0.5 and 0.8 mm. This applies especially if the TC tire sidewall mean thickness is relatively small, that is to say less than 3 mm, which makes it possible to reduce the hysteresis losses of the sidewalls.

The meridian profile of the outer wall of the sidewall concerned, at least in the first portion of the sidewall extending the tread, is even more advantageously substantially continuous, that is to say that it features no slope discontinuity. By meridian profile is meant the profile of the outer wall of the sidewall seen in any section plane containing the rotation axis of the tire.

The applicants having observed that the sidewall intended to be on the outside of the vehicle has an impact on the aerodynamic drag, it is advisable to form on this sidewall a specific marking intended to position this sidewall on the outside, this sidewall including distributed markings in accordance with the present invention.

Of course, if the tire has a preferred rolling direction, this tire is preferably made with two sidewalls in accordance with the invention so that it can be mounted either in a right-hand position or in a left-hand position on the same axle.

If the tire has no preferred rolling direction, it is advisable to form the markings in accordance with the invention at least on the flank intended to be on the outside.

Other features and advantages of embodiments of the invention emerge from the description given hereinafter with reference to the appended drawings which show one embodiment of the subject matter of the invention by way of nonlimiting example.

### BRIEF DESCRIPTION OF THE FIGURES

FIG. 1 represents a sectional view of a tire in accordance with an embodiment of the invention;

FIG. 2 represents a view of one sidewall of the tire from FIG. 1.

### DETAILED DESCRIPTION OF SPECIFIC EMBODIMENTS

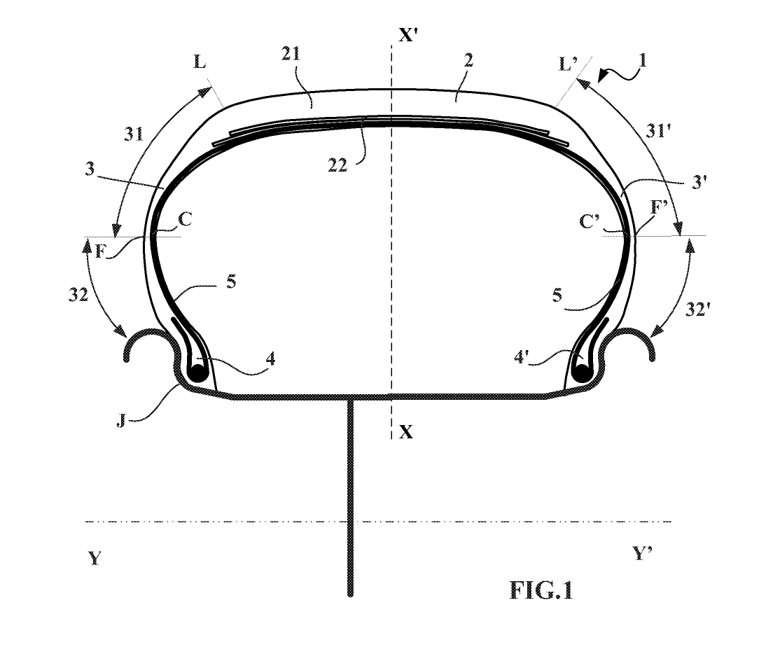

FIG. 1 represents a sectional view of a passenger vehicle tire 1 in accordance with an embodiment of the invention mounted on a mounting rim J. This 205/55 R 16 size tire includes a crown portion provided radially on its outside with a tread 21 intended to come into contact with a road surface when rolling. This crown portion 2 is reinforced by a reinforcing armature 22 and is extended laterally by its sidewalls 3, 3′ terminating in beads 4, 4′ making the contact with the rim J. The tire 1 includes a carcass armature 5 extending from one bead to the other via the sidewalls 3, 3′.

Each sidewall 3 and 3′ includes an inner wall in contact with the gas inflating the tire and an outer wall on which markings visible to the user are formed.

In the configuration represented, the tire is inflated to its pressure of use and adopts a profile in equilibrium. In this configuration, the carcass armature passes through respective points C, C′ in the sidewalls 3 and 3′ that are the axially outermost points relative to the equatorial median plane XX'. These points C and C′ determine respective points F and F′ on the outer walls of the sidewalls 3 and 3′. These points F and F′ are defined by the intersection with the outer wall of each sidewall of a straight line parallel to the rotation axis YY′ and passing through each of the points C and C′.

Points L and L′ are marked on the FIG. 1 meridian section: these points L and L′ correspond to the lateral limits of contact of the tread with the ground when the tire inflated to its usage pressure is subjected to its usage load.

Each sidewall 3 (respectively 3′) is divided into a first portion 31 (respectively 31′) and a second portion 32 (respectively 32′). The first portion 31 extending between the point F and the point L, the second portion 32 extending the first portion 31 toward the bead 4.

The tire in accordance with an embodiment of the invention is such that the molded markings that are formed in the first portions 31 and 31′ comply with the following rule:

three first sectors 311 and three second sectors 312 are formed on each sidewall 3, 3′, these first and second sectors being formed on the outer wall of its first sidewall portion 31;

the first sectors 311 are completely without raised markings, that is to say raised markings more than 0.2 mm high and any roughness more than 0.2 mm high;

the second sectors 312 are provided with raised markings 3120, these raised markings having a height equal on average to 0.6 mm.

Furthermore, the first sectors 311 without markings each form an angle substantially equal to 90° and the sum of the angles of said first sectors is equal to 270°. The second sectors form angles substantially equal to 30°.

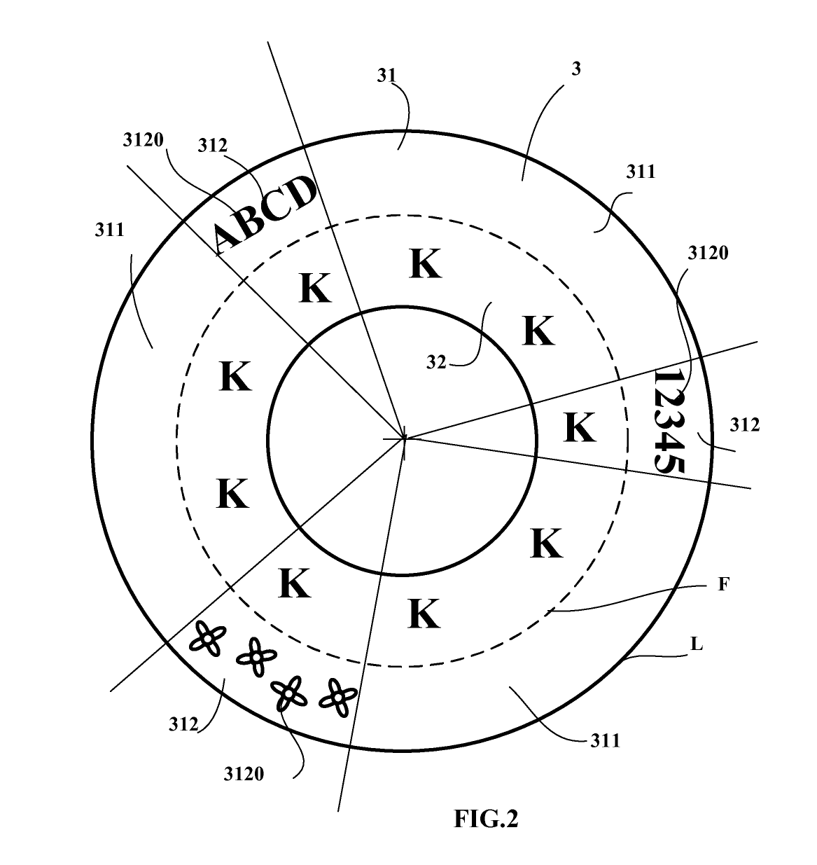

Each sector is determined by tracing two planes containing the rotation axis of the tire and framing as closely as possible the limits of each marking, as can be seen in FIG. 2.

In this FIG. 2 there has been represented a view of one of the sidewalls of the tire from FIG. 1. On this sidewall 3, three first sectors 311 completely without markings can be distinguished on the first sidewall portion 31, this first sidewall portion 31 being contained between a circle passing through the points F and a circle passing through the points L.

Furthermore, three second sectors 312 include raised markings 3120 on the wall surface of the first sidewall portion. The height of the raised markings 3120 is on average equal to 0.6 mm in the present case. The first sectors and the second sectors are placed alternately.

Statutory raised markings of a height equal to 1.0 mm, represented here by letters K, are formed on the second sidewall portions 32; these statutory markings have no significant impact on the aerodynamic drag, as verified during wind tunnel tests.

The first sectors without markings each form an angle substantially equal to 90°. The second sectors form angles substantially equal to 30°.

It is to be noted that the first sectors may be provided with recessed markings of a depth equal to at most 1.5 mm without this significantly modifying the aerodynamic drag of the tire.

What is more, given their very limited number, raised portions of material formed during molding in the venting orifices formed on the molds for the tire should not be considered as markings generating a significant portion of the aerodynamic drag. Of course, their elimination is desirable.

The invention, which has been described by means of an example, is not limited to the example described and represented and diverse modifications may be made to it without departing from the scope of the invention as defined by the claims. It is notably possible to produce markings on the first sidewall sectors by application of self-adhesive labels or “stickers” of appropriate colour and of a thickness equal to at most 0.2 mm.

1. A tire for equipping a passenger vehicle, comprising:
a crown portion provided on an exterior thereof with a tread intended to come into contact with a road surface when rolling,
sidewalls laterally extending the crown portion,
beads terminating the sidewalls, and adapted to be in contact with rim parts (J) on which the tire is mounted,
wherein each sidewall comprises:
an inner wall in contact with air inflating the tire, and
an outer wall in contact with external air,
wherein at least one of the sidewalls comprises:
a plurality of first sectors and second sectors, wherein these first and second sectors are formed on the outer wall of a first sidewall portion located between the crown portion and points (F) that are the axially outermost points when this tire is mounted on its mounting rim and inflated to its usage pressure,
wherein the first sectors are completely without raised markings, i.e. raised markings of a height greater than 0.2 mm,
wherein the second sectors are provided with raised markings, these raised markings having a height equal to at least 0.2 mm,
wherein the first sectors without markings each form an angle equal to at least 20°, and
wherein the sum of the angles of said first sectors is equal to at least 120°.

2. The tire according to claim 1, wherein the first sectors are provided with recessed markings, these recessed markings having a depth equal to at most 1.5 mm.

3. The tire according to claim 2, wherein the recessed markings of the first sectors have a depth between at least 0.5 mm and at most 0.8 mm.

4. The tire according to claim 1, wherein the raised markings of the second sectors have a height equal to at most 1.5 mm.

5. The tire according to claim 4, wherein the raised markings of the second sectors have a height between 0.5 mm and 0.8 mm.

6. The tire according to claim 1, wherein the meridian profile of the outer wall of the sidewall is substantially continuous, i.e. features no slope discontinuity, at least in the first portion (31) of the sidewall.

7. The tire according to claim 1, wherein the sidewall provided with first sectors without markings higher than 0.2 mm and second sectors provided with raised markings, this sidewall adapted to be on the outside of the vehicle, further comprises a specific mark intended to position this sidewall on the outside of the vehicle.
